(19) United States
(12) Patent Application Publication
(10) Pub. No.: US 2023/0269808 A1
(43) Pub. Date: Aug. 24, 2023

(54) APPARATUSES AND METHODS FOR UPDATING ACCESS TECHNOLOGY INFORMATION FOR A MULTI-ACCESS PROTOCOL DATA UNIT (MA PDU) SESSION

(71) Applicant: MEDIATEK INC., Hsinchu City (TW)

(72) Inventors: Ssu-Hsien WU, Hsinchu City (TW); Po-Chun LEE, Hsinchu City (TW); Che-Wei HSU, Hsinchu City (TW)

(21) Appl. No.: 17/677,317

(22) Filed: Feb. 22, 2022

(51) Int. Cl. H04W 76/16; H04L 65/10; H04W 4/12; H04L 65/1069; H04L 65/1016

(52) U.S. Cl. CPC H04W 76/16; H04L 65/1006; H04W 4/12; H04L 65/1069; H04L 65/1016

(57) ABSTRACT

A method for updating access technology information for a Multi-Access (MA) Protocol Data Unit (PDU) session is provided. A User Equipment (UE) establishes an MA PDU session with a mobile communication network over a 3rd Generation Partnership Project (3GPP) access and a non-3GPP access. The UE provides first access technology information indicating to the mobile communication network that the UE is using one of the 3GPP access and the non-3GPP access to get an Internet Protocol (IP) connectivity. The UE detects that the IP connectivity over the one of the 3GPP access and the non-3GPP access is deactivated. The UE provides second access technology information indicating to the mobile communication network that the UE is using the other of the 3GPP access and the non-3GPP access to get another IP connectivity.

### BACKGROUND OF THE APPLICATION

### Field of the Application

The application generally relates to mobile communications, and more particularly, to apparatuses and methods for updating access technology information for a Multi-Access (MA) Protocol Data Unit (PDU) session.

### Description of the Related Art

In a typical mobile communication environment, a UE (also called a Mobile Station (MS)), such as a mobile telephone (also known as a cellular or cell phone), or a tablet Personal Computer (PC) with wireless communication capability, may communicate voice and/or data signals with one or more mobile communication networks. The wireless communication between the UE and the mobile communication networks may be performed using various Radio Access Technologies (RATs), such as Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA-2000) technology, Time Division-Synchronous Code Division Multiple Access (TD-SCDMA) technology, Worldwide Interoperability for Microwave Access (WiMAX) technology, Long Term Evolution (LTE) technology, LTE-Advanced (LTE-A) technology, etc. In particular, GSM/GPRS/EDGE technology is also called 2G technology; WCDMA/CDMA-2000/TD-SCDMA technology is also called 3G technology; and LTE/LTE-A/TD-LTE technology is also called 4G technology.

These RAT technologies have been adopted for use in various telecommunication standards to provide a common protocol that enables different wireless devices to communicate on a municipal, national, regional, and even global level. An example of an emerging telecommunication standard is the 5G New Radio (NR). The 5G NR is a set of enhancements to the LTE mobile standard promulgated by the 3rd Generation Partnership Project (3GPP). It is designed to better support mobile broadband Internet access by improving spectral efficiency, reducing costs, and improving services.

In 5G NR, a Protocol Data Unit (PDU) session defines the association between the TIE and the mobile communication network that provides an Internet Protocol (IP) connectivity service. In general, each PDU session may be established over 3GPP access or non-3GPP access. Operators are seeking ways to balance data traffic between 3GPP access and non-3GPP access in a way that is transparent to users and reduces mobile network congestion. As UEs can be simultaneously connected to both 3GPP access and non-3GPP access, the 5G System (5GS) is able to take advantage of these multiple access types to improve the user experience and optimize the traffic distribution across various access types. Accordingly, the 3GPP introduced Multi-Access (MA) PDU session in 5GS. An MA PDU session can be configured to use either 3GPP access or non-3GPP access at a time, or simultaneously use both 3GPP access and non-3GPP access.

When a UE establishes an MA PDU session over both 3GPP access and non-3GPP access, it may be configured to provide the access technology information regarding only one of the two access types to the mobile communication network. However, there are situations where IP connectivity over the access corresponding to the provided access technology information may be deactivated when the MA PDU session is being used. FIG. 1 is a schematic diagram illustrating the scenario of IP connectivity over one access being deactivated for an MA PDU session. At first, the UE establishes an MA PDU session for, e.g., an emergency call, and provides the access technology information indicating 3GPP access at the ground floor of station A where both access types are available. Next, the user of the UE moves to the basement floor of station A where the 3GPP access is unavailable, but the UE keeps the MA PDU session using the available non-3GPP access. Subsequently, the user takes a train from station A to station B while keeping the MA PDU session with non-3GPP access being available onboard. When the user arrives at the basement floor of station B where only non-3GPP access is available, the mobile communication network still uses the previously received access technology information to derive the UE's location information. As a result, the derived location information will be incorrect.

### BRIEF SUMMARY OF THE APPLICATION

In order to solve the aforementioned problem, the present application proposes to update the access technology information, by allowing the UE to provide the access technology information indicative of the alternative access when detecting that the IP connectivity over the access indicated by the previously provided access technology information is deactivated. Advantageously, the mobile communication network may obtain up-to-date access technology information to derive the correct location information of the UE.

In one aspect of the application, a method for updating access technology information for an MA PDU session is provided. The method comprises the following steps: establishing an MA PDU session with a mobile communication network by a UE, wherein the MA PDU session is established over a 3GPP access and a non-3GPP access; providing first access technology information indicating to the mobile communication network that the UE is using one of the 3GPP access and the non-3GPP access to get an IP connectivity; detecting that the IP connectivity over the one of the 3GPP access and the non-3GPP access is deactivated; and providing second access technology information indicating to the mobile communication network that the UE is using the other of the 3GPP access and the non-3GPP access to get another IP connectivity.

In another aspect of the application, a UE comprising a wireless transceiver and a controller is provided. The wireless transceiver is configured to perform wireless transmission and reception to and from a 3GPP access and a non-3GPP access. The controller is configured to establish an MA PDU session with a mobile communication network over the 3GPP access and the non-3GPP access, provide first access technology information indicating to the mobile communication network that the UE is using one of the 3GPP access and the non-3GPP access to get an IP connectivity, detect that the IP connectivity over the one of the 3GPP access and the non-3GPP access is deactivated, and provide second access technology information indicating to the mobile communication network that the UE is using the other of the 3GPP access and the non-3GPP access to get another IP connectivity.

In one example, each of the first access technology information and the second access technology information is provided in a respective Session Initiation Protocol (SIP) message. The SIP message may comprise a P-Access-Network-Info header indicating the first access technology information or the second access technology information. The SIP message may be a SIP INVITE message, a SIP REGISTER message, a SIP OPTION message, or a SIP UPDATE message.

In one example, the detection of the IP connectivity deactivation comprises: detecting that user-plane resources associated with the one of the 3GPP access and the non-3GPP access are released. The user-plane resources associated with the one of the 3GPP access and the non-3GPP access may be released in response to receiving a PDU SESSION RELEASE COMMAND message from the mobile communication network or sending a PDU SESSION RELEASE REQUEST message to the mobile communication network.

In one example, the first access technology information is provided in response to the UE requesting an IP Multimedia Subsystem (IMS) service on the MA PDU session. The IMS service may comprise a call service, an instant messaging service, a conferencing service, a gaming service, or a TV broadcasting service.

In one example, the MA PDU session is maintained when the IP connectivity over the one of the 3GPP access and the non-3GPP access is deactivated.

In one example, the first access technology information is provided before the IP connectivity over the one of the 3GPP access and the non-3GPP access is deactivated, and the second access technology information is provided in response to detecting that the IP connectivity over the one of the 3GPP access and the non-3GPP access is deactivated.

Other aspects and features of the present application will become apparent to those with ordinary skill in the art upon review of the following descriptions of specific embodiments of the apparatuses and methods for updating access technology information for an MA PDU session.

### BRIEF DESCRIPTION OF DRAWINGS

The application can be more fully understood by reading the subsequent detailed description and examples with references made to the accompanying drawings, wherein:

FIG. 1 is a schematic diagram illustrating the scenario of IP connectivity over one access being deactivated for an MA PDU session;

FIG. 2 is a block diagram of a mobile communication environment according to an embodiment of the application;

FIG. 3 is a block diagram illustrating a UE according to an embodiment of the application;

FIGS. 4A and 4B are schematic diagrams illustrating an exemplary scenario of updating access technology information for an MA PDU session according to an embodiment of the application;

FIG. 5 is a message sequence chart illustrating the network-requested PDU session release procedure according to an embodiment of the application;

FIG. 6 is a message sequence chart illustrating the UE-requested PDU session release procedure according to an embodiment of the application; and

FIG. 7 is a flow chart illustrating the method for updating access technology information for an MA PDU session according to an embodiment of the application.

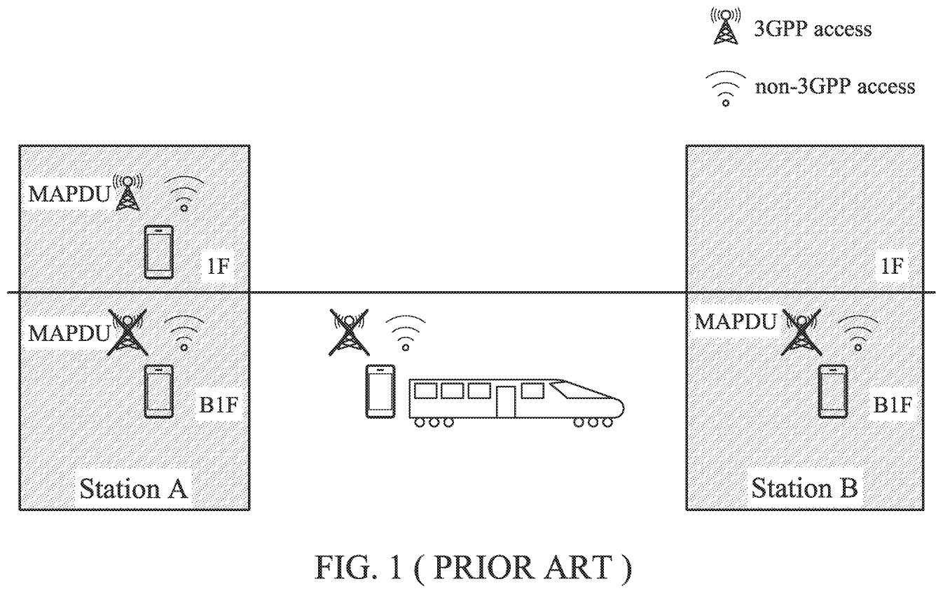

### DETAILED DESCRIPTION OF THE APPLICATION

The following description is made for the purpose of illustrating the general principles of the application and should not be taken in a limiting sense. It should be understood that the embodiments may be realized in software, hardware, firmware, or any combination thereof. The terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

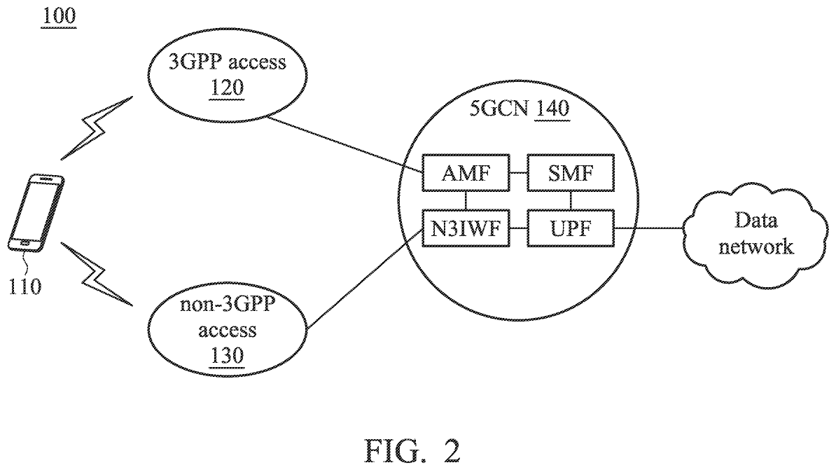

FIG. 2 is a block diagram of a mobile communication environment according to an embodiment of the application.

The mobile communication environment 100 includes a UE 110, a 3GPP access 120, a non-3GPP access 130, and a 3GPP core network which is exemplified by a 5G Core Network (5GCN) 140.

The UE 110 may be a feature phone, a smartphone, a tablet PC, a laptop computer, or any wireless communication device supporting the RATs utilized by the 3GPP access 120, the non-3GPP access 130, and the 5GCN 140. The UE 110 may be wirelessly connected to the 5GCN 140 via the 3GPP access 120 and/or the non-3GPP access 130.

The 3GPP access 120 may refer to an access network utilizing one of the RATs specified by 3GPP. For example, the 3GPP access 120 may include a GSM EDGE Radio Access Network (GERAN), Universal Terrestrial Radio Access Network (UTRAN), Evolved UTRAN (E-UTRAN), or Next Generation Radio Access Network (NG-RAN).

In one example, the 3GPP access 120 may include a GERAN if the utilized RAT is the GSM/EDGE/GPRS technology, and the GERAN may include at least a Base Transceiver Station (BTS) and a Base Station Controller (BSC).

In one example, the 3GPP access 120 may include a UTRAN if the utilized RAT is the WCDMA technology, and the UTRAN may include at least one NodeB (NB).

In one example, the 3GPP access 120 may include an E-UTRAN if the utilized RAT is the LTE/LTE-A/TD-LTE technology, and the E-UTRAN may include at least one evolved NodeB (eNB) (e.g., macro eNB, femto eNB, or pico eNB).

In one example, the 3GPP access 120 may include an NG-RAN if the utilized RAT is the 5G NR technology, and the NG-RAN may include one or more gNBs. Each gNB may further include one or more Transmission Reception Points (TRPs), and each gNB or TRP may be referred to as a 5G cellular station. Some gNB functions may be distributed across different TRPs, while others may be centralized, leaving the flexibility and scope of specific deployments to fulfill the requirements for specific cases.

The non-3GPP access 130 may refer to an access network utilizing one RAT not specified by 3GPP. For example, the non-3GPP access 130 may include a Wireless-Fidelity (Wi-Fi) network, a WiMAX network, a CDMA network, or a fixed network (e.g., a Digital Subscriber Line (DSL) network).

Each of the 3GPP access 120 and the non-3GPP access 130 is capable of providing the functions of processing radio signals, terminating radio protocols, and connecting the UE 110 with the 5GCN 140, while the 5GCN 140 is responsible for performing mobility management, network-side authentication, and interfaces with a public/external data network (e.g., the Internet).

The 5GCN 140 may also be called a Next Generation Core Network (NG-CN) in the 5G NR technology, and it may support various network functions, including an Access and Mobility Management Function (AMF), a Session Management Function (SMF), a User Plane Function (UPF), a Policy Control Function (PCF), an Application Function (AF), an Authentication Server Function (AUSF), and a Non-3GPP Inter-Working Function (N3IWF), wherein each network function may be implemented as a network element on dedicated hardware, or as a software instance running on dedicated hardware, or as a virtualized function instantiated on an appropriate platform, e.g., a cloud infrastructure.

The AMF provides UE-based authentication, authorization, mobility management, etc. The SMF is responsible for session management and allocates Internet Protocol (IP) addresses to UEs. It also selects and controls the UPF for data transfer. If a UE has multiple sessions, different SMFs may be allocated to each session to manage them individually and possibly provide different functions per session. Specifically, 5G Session Management (5GSM) for PDU sessions over both 3GPP access and non-3GPP access are managed by AMF and SMF via NAS signaling, such as the PDU session establishment procedure, the PDU session modification procedure, and the PDU session release procedure, which may be initiated by the network or the UE for managing PDU sessions. The AF provides information on the packet flow to PCF responsible for policy control in order to support Quality of Service (QoS). Based on the information, the PCF determines policies about mobility and session management to make the AMF and the SMF operate properly. The AUSF stores data for authentication of UEs, while the UDM stores subscription data of UEs. The N3IWF may enable the UE 110 to attach to the 5GCN 140 either via trusted non-3GPP access or via untrusted non-3GPP access.

The UE 110 may establish an MA PDU session with the 5GCN 140 over both the 3GPP access 120 and the non-3GPP access 130, and provide the access technology information in a Session Initiation Protocol (SIP) INVITE message to request an IP Multimedia Subsystem (IMS) service, such as call service (e.g., emergency call service), instant messaging service, conferencing service, gaming service, or TV broadcasting service. In particular, the access technology information is indicative of only one of the 3GPP access 120 and the non-3GPP access 130 that the UE 110 uses to get an IP connectivity.

In accordance with one novel aspect, the UE 110 is allowed to update the access technology information, by providing the access technology information indicative of the alternative access when detecting that the IP connectivity over the access indicated by the previously provided access technology information is deactivated. Advantageously, the mobile communication network may obtain the up-to-date access technology information to derive the correct location information of the UE.

It should be understood that the 5GCN 140 depicted in FIG. 2 is for illustrative purposes only and are not intended to limit the scope of the application. For example, the UE 110 may be wirelessly connected to other 3GPP core networks (e.g., future evolution of the 5GCN, such as 6GCN, and 7GCN, etc.) over the 3GPP access 120 and/or the non-3GPP access 130.

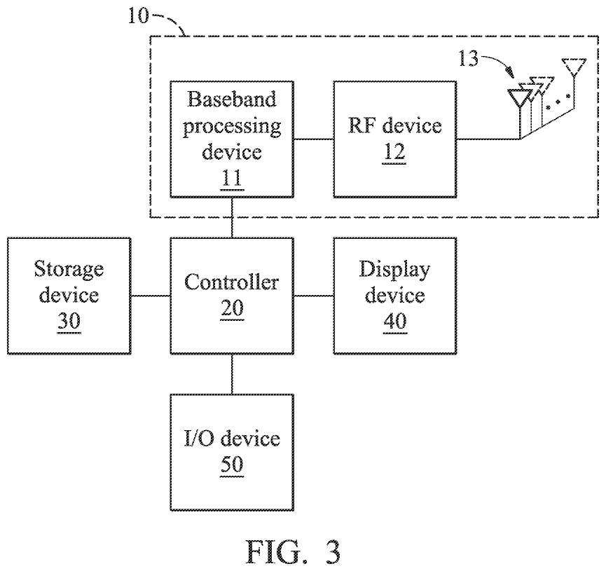

FIG. 3 is a block diagram illustrating a UE according to an embodiment of the application.

As shown in FIG. 3, a UE (e.g., the UE 110) may include a wireless transceiver 10, a controller 20, a storage device 30, a display device 40, and an Input/Output (I/O) device 50.

The wireless transceiver 10 is configured to perform wireless transmission and reception to and from the non-3GPP access network 120 and/or the access network of the 3GPP network 140. Specifically, the wireless transceiver 10 may include a baseband processing device 11, a Radio Frequency (RF) device 12, and an antenna 13, wherein the antenna 13 may include an antenna array for beamforming.

The baseband processing device 11 is configured to perform baseband signal processing. The baseband processing device 11 may contain multiple hardware components to perform the baseband signal processing, including Analog-to-Digital Conversion (ADC)/Digital-to-Analog Conversion (DAC), gain adjusting, modulation/demodulation, encoding/decoding, and so on.

The RF device 12 may receive RF wireless signals via the antenna 13, convert the received RF wireless signals to baseband signals, which are processed by the baseband processing device 11, or receive baseband signals from the baseband processing device 11 and convert the received baseband signals to RF wireless signals, which are later transmitted via the antenna 13. The RF device 12 may also contain multiple hardware devices to perform radio frequency conversion. For example, the RF device 12 may comprise a mixer to multiply the baseband signals with a carrier oscillated in the radio frequency of the supported RAT(s), wherein the radio frequency may be 900 MHz, 2100 MHz, or 2.6 GHz utilized in 4G LTE/LTE-A/TD-LTE technology, or may be any radio frequency (e.g., 30 GHz˜300 GHz for mmWave) utilized in the 5G NR technology, or another radio frequency, depending on the RAT in use.

The controller 20 may be a general-purpose processor, a Micro Control Unit (MCU), an application processor, a Digital Signal Processor (DSP), a Graphics Processing Unit (GPU), a Holographic Processing Unit (HPU), a Neural Processing Unit (NPU), or the like, which includes various circuits for providing the functions of data processing and computing, controlling the wireless transceiver 10 for wireless communication with the non-3GPP access network 120 and/or the access network of the 3GPP network 140, storing and retrieving data to and from the storage device 30, sending a series of frame data (e.g. representing text messages, graphics, images, etc.) to the display device 40, and receiving user inputs or outputting signals via the I/O device 50.

In particular, the controller 20 coordinates the aforementioned operations of the wireless transceiver 10, the storage device 30, the display device 40, and the I/O device 50 to perform the method of the present application.

In another embodiment, the controller 20 may be incorporated into the baseband processing device 11, to serve as a baseband processor.

As will be appreciated by persons skilled in the art, the circuits of the controller 20 will typically include transistors that are configured in such a way as to control the operation of the circuits in accordance with the functions and operations described herein. As will be further appreciated, the specific structure or interconnections of the transistors will typically be determined by a compiler, such as a Register Transfer Language (RTL) compiler. RTL compilers may be operated by a processor upon scripts that closely resemble assembly language code, to compile the script into a form that is used for the layout or fabrication of the ultimate circuitry. Indeed, RTL is well known for its role and use in the facilitation of the design process of electronic and digital systems.

The storage device 30 may be a non-transitory machine-readable storage medium, including a non-volatile memory (e.g., a FLASH memory or a Non-Volatile Random Access Memory (NVRAM)), or a Universal Integrated Circuit Card (UICC) (e.g., a Subscriber Identity Module (SIM) or Universal SIM (USIM)), or a magnetic storage device (e.g., a hard disk or a magnetic tape), or an optical disc, or any combination thereof for storing data, instructions, and/or program code of applications, communication protocols (e.g., the SIP and the 4G/5G protocol), and/or the method of the present application. In one example, the method of the present application may be implemented as part of the SIP and/or the 4G/5G protocol. A 4G/5G protocol stack may include a Non-Access-Stratum (NAS) layer to communicate with an AMF/SMF/MME entity in the 3GPP core network, and an Access Stratum (AS) layer consisting of multiple sublayers, such as a Radio Resource Control (RRC) sublayer for high layer configuration and control of, a Packet Data Convergence Protocol/Radio Link Control (PDCP/RLC) sublayer, a Media Access Control (MAC) sublayer, and a Physical (PHY) sublayer.

The display device 40 may be a Liquid-Crystal Display (LCD), a Light-Emitting Diode (LED) display, an Organic LED (OLED) display, or an Electronic Paper Display (EPD), etc., for providing a display function. Alternatively, the display device 40 may further include one or more touch sensors disposed thereon or thereunder for sensing touches, contacts, or approximations of objects, such as fingers or styluses.

The I/O device 50 may include one or more buttons, a keyboard, a mouse, a touch pad, a video camera, a microphone, and/or a speaker, etc., to serve as the Man-Machine Interface (MMI) for interaction with users.

It should be understood that the components described in the embodiment of FIG. 3 are for illustrative purposes only and are not intended to limit the scope of the application. For example, a UE may include more components, such as a power supply, or a Global Positioning System (GPS) device, wherein the power supply may be a mobile/replaceable battery providing power to all the other components of the UE, and the GPS device may provide the location information of the UE for use by some location-based services or applications. Alternatively, a UE may include fewer components. For example, the UE may not include the display device 40 and/or the I/O device 50.

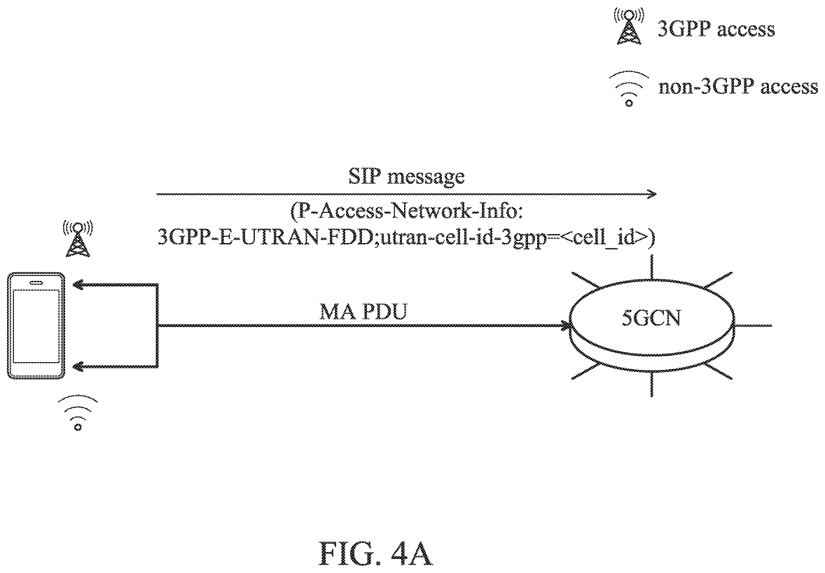

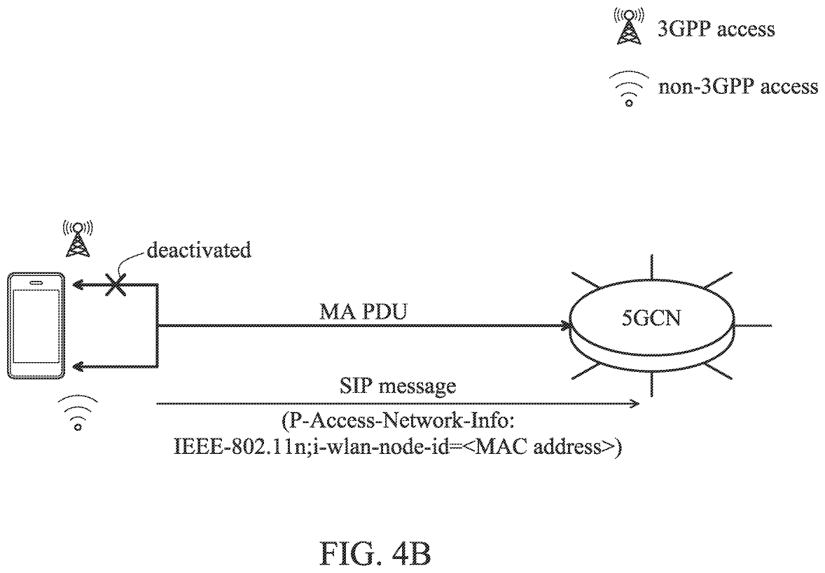

FIGS. 4A and 4B are schematic diagrams illustrating an exemplary scenario of updating access technology information for an MA PDU session according to an embodiment of the application.

As shown in FIG. 4A, the UE establishes an MA PDU session with the 5GCN over 3GPP access and non-3GPP access, and provides the access technology information in the P-Access-Network-Info header of a SIP message (e.g., a SIP INVITE message, a SIP REGISTER message, a SIP OPTION message, or a SIP UPDATE message) to the 5GCN. In particular, the access technology information indicates that the UE is using 3GPP access to get an IP connectivity.

As shown in FIG. 4B, the UE detects that the IP connectivity over 3GPP access is deactivated, and accordingly, provides updated access technology information in the P-Access-Network-Info header of a SIP message (e.g., a SIP INVITE message, a SIP REGISTER message, a SIP OPTION message, or a SIP UPDATE message) to the 5GCN. Specifically, the updated access technology information indicates that the UE is using non-3GPP access to get another IP connectivity.

It should be noted that the MA PDU session is maintained when the IP connectivity over 3GPP access is deactivated, due to that the MA PDU session still has user-plane resources established on non-3GPP access.

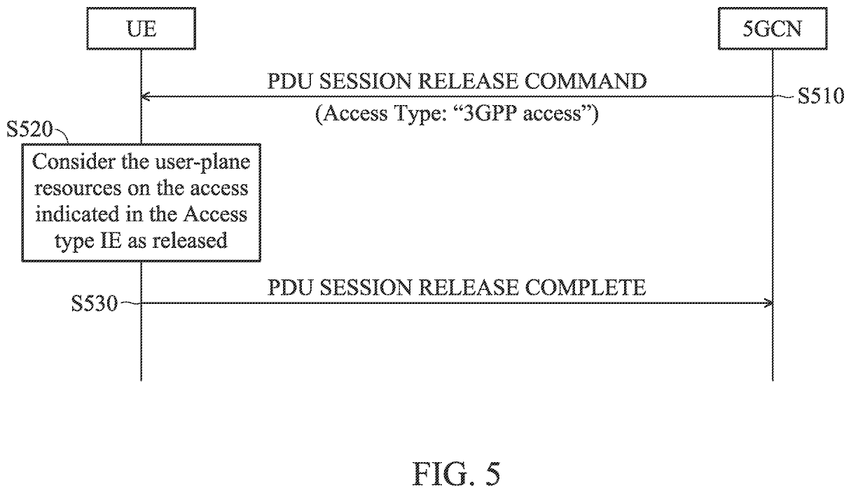

To clarify further, the detection of the IP connectivity deactivation may include detecting that the user-plane resources associated with 3GPP access are released. The details of the release of user user-plane resources associated with 3GPP access or non-3GPP access for an MA PDU session will be described in FIGS. 5˜6 as follows.

FIG. 5 is a message sequence chart illustrating the network-requested PDU session release procedure according to an embodiment of the application.

In step S510, the UE receives a PDU SESSION RELEASE COMMAND message including an Access Type Information Element (IE) indicating “3GPP access”. Please note that in another embodiment, the Access Type IE may indicate “non-3GPP access” if the current IP connectivity is obtained using non-3GPP access.

In step S520, the UE considers the user-plane resources on the access indicated in the Access type IE as released (i.e., detects that the current IP connectivity obtained using 3GPP access is deactivated).

In step S530, the UE sends a PDU SESSION RELEASE COMPLETE message to the 5GCN, and the procedure ends.

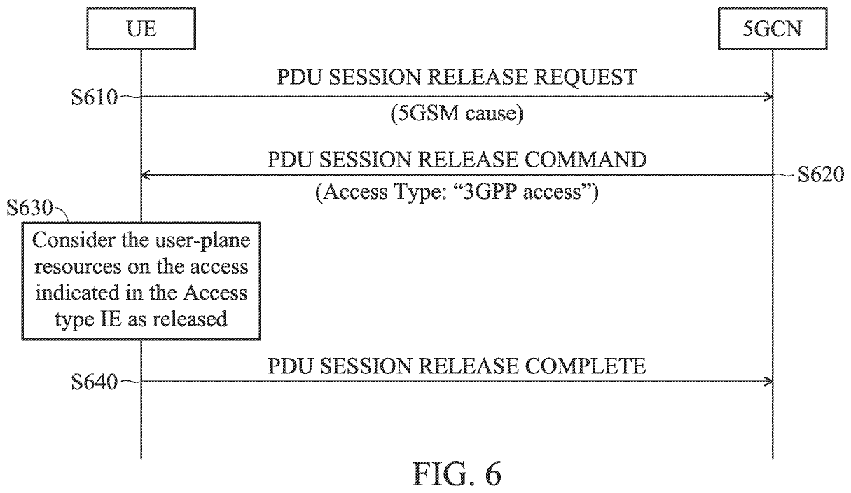

FIG. 6 is a message sequence chart illustrating the UE-requested PDU session release procedure according to an embodiment of the application.

In step S610, the UE sends a PDU SESSION RELEASE REQUEST message including a 5GSM cause IE indicating the reason for initiating this procedure. For example, the 5GSM cause IE typically indicates one of the following 5GSM cause values: #36 “regular deactivation”, #41 “Semantic error in the TFT operation”, #42 “Syntactical error in the TFT operation”, #44 “Semantic errors in packet filter(s)”, and #45 “Syntactical error in packet filter(s)”. Basically, the UE may initiate this procedure due to errors in QoS operations or packet filters, or due to that the number of the authorized QoS rules, the number of the packet filters, or the number of the authorized QoS flow descriptions associated with the PDU session have reached the maximum number supported by the UE.

Upon receipt of the PDU SESSION RELEASE REQUEST message, the 5GCN accepts the request and performs the network-requested PDU session release procedure as depicted in FIG. 5 to follow through the release of user user-plane resources associated with 3GPP access. That is, steps S620˜S640 are the same as steps S510˜S530 in the embodiment of FIG. 5, and detailed description of steps S620˜S640 is omitted herein for brevity.

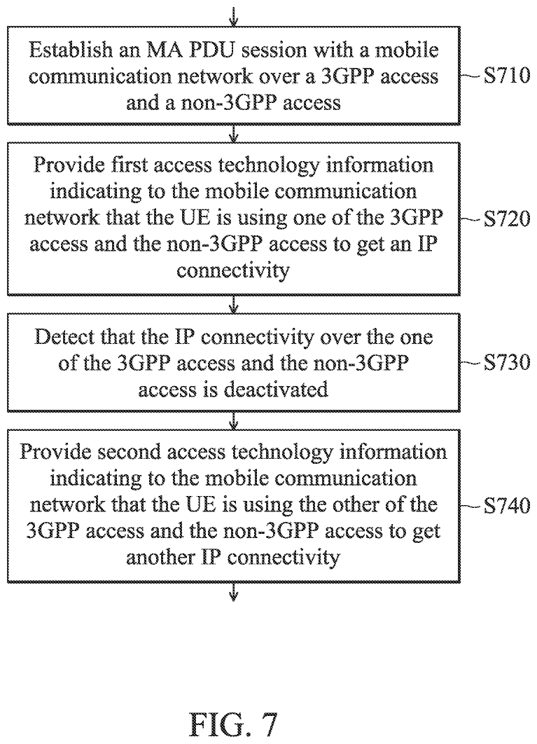

FIG. 7 is a flow chart illustrating the method for updating access technology information for an MA PDU session according to an embodiment of the application.

In step S710, the UE establishes an MA PDU session with a mobile communication network over a 3GPP access and a non-3GPP access.

In step S720, the UE provides first access technology information indicating to the mobile communication network that the UE is using one of the 3GPP access network and the non-3GPP access network to get an IP connectivity.

In step S730, the UE detects that the IP connectivity over the one of the 3GPP access network and the non-3GPP access network is deactivated.

In step S740, the UE provides second access technology information indicating to the mobile communication network that the UE is using the other of the 3GPP access network and the non-3GPP access network to get another IP connectivity.

While the application has been described by way of example and in terms of preferred embodiment, it should be understood that the application is not limited thereto. Those who are skilled in this technology can still make various alterations and modifications without departing from the scope and spirit of this application. Therefore, the scope of the present application shall be defined and protected by the following claims and their equivalents.

Use of ordinal terms such as “first”, “second”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

What is claimed is:

1. A method, comprising:
establishing a Multi-Access (MA) Protocol Data Unit (PDU) session with a mobile communication network by a User Equipment (UE), wherein the MA PDU session is established over a 3rd Generation Partnership Project (3GPP) access and a non-3GPP access;
providing first access technology information indicating to the mobile communication network that the UE is using one of the 3GPP access and the non-3GPP access to get an Internet Protocol (IP) connectivity;
detecting that the IP connectivity over the one of the 3GPP access and the non-3GPP access is deactivated; and
providing second access technology information indicating to the mobile communication network that the UE is using the other of the 3GPP access and the non-3GPP access to get another IP connectivity.

2. The method as claimed in claim 1, wherein each of the first access technology information and the second access technology information is provided in a respective Session Initiation Protocol (SIP) message.

3. The method as claimed in claim 2, wherein the SIP message comprises a P-Access-Network-Info header indicating the first access technology information or the second access technology information.

4. The method as claimed in claim 2, wherein the SIP message is a SIP INVITE message, a SIP REGISTER message, a SIP OPTION message, or a SIP UPDATE message.

5. The method as claimed in claim 1, wherein the detection of the IP connectivity deactivation comprises:
detecting that user-plane resources associated with the one of the 3GPP access and the non-3GPP access are released.

6. The method as claimed in claim 5, wherein the user-plane resources associated with the one of the 3GPP access and the non-3GPP access are released in response to receiving a PDU SESSION RELEASE COMMAND message from the mobile communication network or sending a PDU SESSION RELEASE REQUEST message to the mobile communication network.

7. The method as claimed in claim 1, wherein the first access technology information is provided in response to the UE requesting an IP Multimedia Subsystem (IMS) service on the MA PDU session.

8. The method as claimed in claim 7, wherein the IMS service comprises a call service, an instant messaging service, a conferencing service, a gaming service, or a TV broadcasting service.

9. The method as claimed in claim 1, wherein the MA PDU session is maintained when the IP connectivity over the one of the 3GPP access and the non-3GPP access is deactivated.

10. The method as claimed in claim 1, wherein the first access technology information is provided before the IP connectivity over the one of the 3GPP access and the non-3GPP access is deactivated, and the second access technology information is provided in response to detecting that the IP connectivity over the one of the 3GPP access and the non-3GPP access is deactivated.

11. A User Equipment (UE), comprising:
a wireless transceiver, configured to perform wireless transmission and reception to and from a 3rd Generation Partnership Project (3GPP) access and a non-3GPP access; and
a controller, configured to establish a Multi-Access (MA) Protocol Data Unit (PDU) session with a mobile communication network over the 3GPP access and the non-3GPP access, provide first access technology information indicating to the mobile communication network that the UE is using one of the 3GPP access and the non-3GPP access to get an Internet Protocol (IP) connectivity, detect that the IP connectivity over the one of the 3GPP access and the non-3GPP access is deactivated, and provide second access technology information indicating to the mobile communication network that the UE is using the other of the 3GPP access and the non-3GPP access to get another IP connectivity.

12. The UE as claimed in claim 11, wherein each of the first access technology information and the second access technology information is provided in a respective Session Initiation Protocol (SIP) message.

13. The UE as claimed in claim 12, wherein the SIP message comprises a P-Access-Network-Info header indicating the first access technology information or the second access technology information.

14. The UE as claimed in claim 12, wherein the SIP message is a SIP INVITE message, a SIP REGISTER message, a SIP OPTION message, or a SIP UPDATE message.

15. The UE as claimed in claim 11, wherein the detection of the IP connectivity deactivation comprises:
detecting that user-plane resources associated with the one of the 3GPP access and the non-3GPP access are released.

16. The UE as claimed in claim 15, wherein the user-plane resources associated with the one of the 3GPP access and the non-3GPP access are released in response to receiving a PDU SESSION RELEASE COMMAND message from the mobile communication network or sending a PDU SESSION RELEASE REQUEST message to the mobile communication network.

17. The UE as claimed in claim 11, wherein the first access technology information is provided in response to the UE requesting an IP Multimedia Subsystem (IMS) service on the MA PDU session.

18. The UE as claimed in claim 17, wherein the IMS service comprises a call service, an instant messaging service, a conferencing service, a gaming service, or a TV broadcasting service.

19. The UE as claimed in claim 11, wherein the MA PDU session is maintained when the IP connectivity over the one of the 3GPP access and the non-3GPP access is deactivated.

20. The UE as claimed in claim 11, wherein the first access technology information is provided before the IP connectivity over the one of the 3GPP access and the non-3GPP access is deactivated, and the second access technology information is provided in response to detecting that the IP connectivity over the one of the 3GPP access and the non-3GPP access is deactivated.
